(19) United States
(12) Patent Application Publication
(10) Pub. No.: US 2024/0297322 A1
(43) Pub. Date: Sep. 5, 2024

(54) CATION EXCHANGE MEMBRANE FOR FUEL CELL WITH PEDOT INTRODUCED INTO HYDROCARBON-BASED POLYMER AND METHOD FOR MANUFACTURING THE SAME

(71) Applicant: RESEARCH & BUSINESS FOUNDATION SUNGKYUNKWAN UNIVERSITY, Suwon-si (KR)

(72) Inventors: Dukjoon KIM, Seoul (KR); Gyo Young GU, Suwon-si (KR)

(73) Assignee: RESEARCH & BUSINESS FOUNDATION SUNGKYUNKWAN UNIVERSITY, Suwon-si (KR)

(21) Appl. No.: 18/589,646

(22) Filed: Feb. 28, 2024

(30) Foreign Application Priority Data
Mar. 2, 2023 (KR) 10-2023-0027916

(51) Int. Cl. H01M 8/1072; B01J 39/05; B01J 39/19; B01J 47/12; C08J 5/22; H01M 8/10; H01M 8/1027; H01M 8/1032

(52) U.S. Cl. CPC H01M 8/1072; B01J 39/05; B01J 39/19; B01J 47/12; C08J 5/2256; C08J 5/2287; H01M 8/1027; H01M 8/1032; C08J 2371/10; C08J 2465/00; H01M 2008/1095

(57) ABSTRACT

The disclosure provides a method for manufacturing a cation exchange membrane for a fuel cell, comprising the steps of providing a first hydrocarbon-based polymer having a sulfonic acid group; forming a mixture by mixing the first hydrocarbon-based polymer with 3,4-ethylenedioxythiophene (EDOT); adding an oxidizing agent to the mixture to prepare a cation exchange membrane; and activating the sulfonic acid group of the cation exchange membrane.

### CROSS REFERENCE TO RELATED APPLICATION

The present application claims priority to Korean Patent Application No. 10-2023-0027916, filed on Mar. 2, 2023, the entire contents of which is incorporated herein for all purposes by this reference.

### BACKGROUND OF THE INVENTION

### Field of the Invention

The present disclosure relates to a cation exchange membrane for fuel cells, and more specifically, to a cation exchange membrane for fuel cells in which PEDOT is introduced into a hydrocarbon-based polymer and a method of manufacturing the same.

### Description of the Related Art

Fuel cells are one of the future alternative energy sources and are a type of power generation device that directly converts chemical energy in fuel into electrical energy. Depending on operating temperature and electrolyte type, fuel cells may be classified into the following categories: polymer exchange membrane fuel cells (PEMFCs), alkali fuel cells (AFCs), phosphoric acid fuel cells (PAFCs), molten carbonate fuel cells (MCFCs), solid oxide fuel cells (SOFCs), and the like.

Among the above fuel cells, the PEMFC has a lower operating temperature, high energy conversion efficiency, high current density and power density, and quick response characteristics to load changes, compared to other fuel cells. In particular, since a polymer membrane is used as the electrolyte, the structure is simple and corrosion does not need to be considered, so various possibilities exist in selecting materials. Therefore, it can be applied to a wide variety of industrial fields in the future, such as power sources for pollution-free vehicles, household power sources, portable power sources, and military power sources.

The cation exchange membrane used in fuel cells is responsible for separating the anode and cathode and for the movement of protons supplied through the fuel, and is a factor that greatly affects the performance of ionic conductivity, which can affect the overall efficiency of a battery.

The PEMFC usually uses DuPont's Nafion membrane, a tetrafluoroethylene-based copolymer containing perfluorosulfonic acid in the side chain, as an electrolyte. Perfluorinated polymers such as Nafion have the advantages of high ionic conductivity and excellent mechanical and chemical stability. However, because the price of Nafion polymer electrolyte is too expensive due to the complex synthesis process, a reduction in the price of the membrane is required for full commercialization of the PEMFC.

In addition, due to the permeability characteristics of Nafion itself for fuel gas and liquid (methanol), fuel usage rate is reduced and driving performance is sharply deteriorated. Therefore, attempts to improve fuel cell performance and simultaneously reduce the amount of Nafion used by increasing conductivity by reducing the thickness of the membrane are unrealistic. Also, conversely, increasing the thickness of the Nafion membrane has the problem of lowering the conductivity and thus lowering the output characteristics of the fuel cell.

In addition, the Nafion polymer electrolyte has poor dimensional stability depending on the degree of hydration, which is not only disadvantageous in the manufacturing process, but also has the problem of deteriorating performance due to deterioration of the interface contact with the numerically stable electrode catalyst layer when operated for a long time.

### DOCUMENTS OF RELATED ART

(Patent Document 1) KR Registered Patent No. 10-0544890

### SUMMARY OF THE INVENTION

The technical object to be achieved by the present disclosure is to provide a cation exchange membrane through the process of using hydrocarbon-based polymers and mixing them with PEDOT to overcome the disadvantages of perfluorinated polymers.

In the case of various hydrocarbon-based cation exchange membranes such as sulfonated poly arylene ether ketone (SPAEK), sulfonated poly ether ether ketone (SPEEK), sulfonated poly arylene ether sulfone (SPAES), sulfonated polybenzimidazol (SPBI), and sulfonated poly fluorene biphenyl indole (SPFBI), which are synthesized through the above blending process, steric hindrance and electrostatic interactions between the main chain of the hydrocarbon-based polymer, sulfonic acid groups, and PEDOT prevent doping and help proton dissociation to improve ionic conductivity. In addition, PEDOT, which is hydrophobic, can improve mechanical stability with low water uptake and swelling ratio.

The technical objects to be achieved by the present disclosure are not limited to the technical objects mentioned above, and other technical objects not mentioned may be clearly understood by those skilled in the art from the following descriptions.

In order to achieve the above technical object, an embodiment of the present disclosure provides a method for manufacturing a cation exchange membrane for a fuel cell.

An embodiment of the present disclosure may provide a method for manufacturing a cation exchange membrane for a fuel cell, comprising the steps of providing a first hydrocarbon-based polymer having a sulfonic acid group (S100); forming a mixture by mixing the first hydrocarbon-based polymer with 3,4-ethylenedioxythiophene (EDOT) (S200); adding an oxidizing agent to the mixture to prepare a cation exchange membrane (S300); and activating the sulfonic acid group of the cation exchange membrane (S400).

In the method for manufacturing a cation exchange membrane for a fuel cell according to an embodiment of the present disclosure, the step of providing the first hydrocarbon-based polymer having the sulfonic acid group may include the steps of providing a second hydrocarbon-based polymer (S10); and synthesize the first hydrocarbon-based polymer having the sulfonic acid group by reacting the second hydrocarbon-based polymer with dual sulfonated poly (arylene ether ketone) (DSPAEK) under a catalyst (S20).

In the method for manufacturing a cation exchange membrane for a fuel cell according to an embodiment of the present disclosure, the second hydrocarbon-based polymer may be polymerized using any one or a mixture of monomers selected from the group consisting of 4,4-bis (4-hydroxyphenyl) valeric acid (BPVA), 4,4-diflourobenzophenol (DFBP), and bisphenol A.

In the method for manufacturing a cation exchange membrane for a fuel cell according to an embodiment of the present disclosure, the second hydrocarbon-based polymer may be any one selected from the group consisting of poly ether ether ketone (PEEK), poly arylene ether sulfone (PAES), polybenzimidazole (PBI), poly fluorine biphenyl indole (PFBI), and poly arylene ether ketone (PAEK).

In the method for manufacturing a cation exchange membrane for a fuel cell according to an embodiment of the present disclosure, the catalyst may include one or more selected from consisting of the group O-(benzotriazole-1-yl)-N,N,N,N-tetramethyluroniumtetrafluoroborate (TBTU) and (N,N-Diisopropylethylamine (DIPEA).

In the method for manufacturing a cation exchange membrane for a fuel cell according to an embodiment of the present disclosure, in the step of synthesizing the first hydrocarbon-based polymer having the sulfonic acid group by reacting the second hydrocarbon-based polymer with dual sulfonated poly (arylene ether ketone) (DSPAEK) under the catalyst, the reaction may be an amidation reaction, the first hydrocarbon-based polymer having the sulfonic acid group may be a double sulfonated hydrocarbon-based polymer.

In the method for manufacturing a cation exchange membrane for a fuel cell according to an embodiment of the present disclosure, the oxidizing agent may be sodium persulfate (SPS).

In order to achieve the above technical object, another embodiment of the present disclosure provides a cation exchange membrane for a fuel cell.

An embodiment of the present disclosure may provide a cation exchange membrane for a fuel cell, comprising a first hydrocarbon-based polymer and poly (3,4-ethylenedioxythiophene) (PEDOT), wherein a structure of the first hydrocarbon-based polymer has a main chain in a form of a carbon ring, a functional group of the first hydrocarbon-based polymer includes a sulfonic acid group, the first hydrocarbon-based polymer and the PEDOT are mixed in a structure that exerts steric hindrance and electrostatic interaction with each other.

In the cation exchange membrane for a fuel cell according to an embodiment of the present disclosure, the first hydrocarbon-based polymer may be any one selected from the group consisting of sulfonated poly ether ether ketone (SPEEK), surfonated poly arylene ether sulfone (SPAES), surfonated polybenzimidazole (SPBI), sulfonated poly fluorine biphenyl indole (SPFBI), and surfonated poly arylene ether ketone (SPAEK).

In the cation exchange membrane for a fuel cell according to an embodiment of the present disclosure, the cation exchange membrane for a fuel cell may have a structure of Formula 1 below:

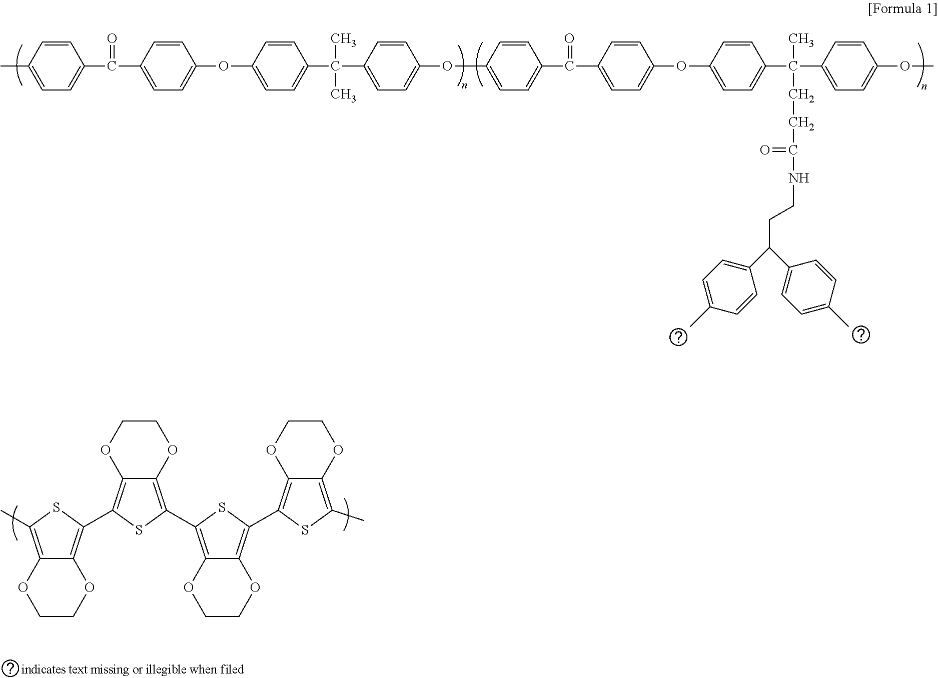

In above Formula 1, n has a value of 0<n<1, m has a value of 0<m<1, synthesis is performed as (m+n)=1.

In the cation exchange membrane for a fuel cell according to an embodiment of the present disclosure, the PEDOT may be mixed at a molar ratio of 0.4 to 2 with respect to 1 mole of the first hydrocarbon-based polymer.

In order to achieve the above technical object, still another embodiment of the present disclosure provides a fuel cell.

According to an embodiment of the present disclosure, a fuel cell comprising an anode, a cathode, and a polymer electrolyte membrane positioned between the anode and the cathode, wherein the polymer electrolyte membrane is the cation exchange membrane for a fuel cell described above may be provided.

According to an embodiment of the present disclosure, the cation exchange membrane for a fuel cell synthesized in the present disclosure is manufactured based on the hydrocarbon-based polymer, so it can solve the problem of high price, which is a disadvantage of existing perfluorinated polymers, and overcome and improve the low ionic conductivity of the hydrocarbon-based polymer compared to the perfluorinated polymer and the influence of water uptake and swelling ratio, which determine mechanical properties, through the introduction of PEDOT.

The effects of the present disclosure are not limited to the above-mentioned effects, and it should be understood that the effects of the present disclosure include all effects that could be inferred from the configuration of the invention described in the detailed description of the invention or the appended claims.

### BRIEF DESCRIPTION OF THE DRAWINGS

FIG. 1 schematically illustrates a manufacturing process of a cation exchange membrane for a fuel cell.

FIG. 2 schematically illustrates a process of synthesizing a first hydrocarbon-based polymer.

FIG. 3 illustrates a chemical structure of DSPAKE:PEDOT in which hydrophobic PEDOT is blended to improve the proton conductivity, water uptake, and swelling ratio of a proton exchange membrane.

FIG. 4 illustrates a chemical structure of hydrocarbon-based polymer, PAEK through amidation synthesis.

FIG. 5 illustrates a chemical structure of sulfonated DSPAEK for use in a fuel cell and proton exchange membrane.

FIG. 6A schematically illustrates a doping process due to an attraction between a flexible structure such as Nafion and PEDOT.

FIG. 6B schematically illustrates a proton dissociation process without doping due to steric hindrance in the case of hydrocarbon-based polymers.

FIG. 7A is a graph showing improved proton conductivity measurements of membranes prepared by blending DSPAEK with PEDOT.

FIG. 7B is a graph showing improved proton conductivity measurements of membranes prepared by blending SPAES120 with PEDOT.

FIG. 7C is a graph showing improved proton conductivity measurements of membranes prepared by blending sPFBI with PEDOT.

FIG. 7D is a graph showing improved proton conductivity measurements of membranes prepared by blending SPEEK with PEDOT.

FIG. 8 is a graph showing proton conductivity measurements of an Nafion:PEDOT membrane to confirm a difference when blending PEDOT with a Nafion membrane, which has a flexible main chain, unlike hydrocarbon-based polymers.

FIG. 9A is a graph showing the water uptake ratio measurements of a membrane blended with hydrophobic PEDOT and pure membrane.

FIG. 9B is a graph showing the swelling ratio measurements of a membrane blended with hydrophobic PEDOT and pure membrane.

### DETAILED DESCRIPTION OF THE INVENTION

Hereinafter, the present disclosure will be explained with reference to the accompanying drawings. The present disclosure, however, may be modified in various different ways, and should not be construed as limited to the embodiments set forth herein. Also, in order to clearly explain the present disclosure, portions that are not related to the present disclosure are omitted, and like reference numerals are used to refer to like elements throughout.

Throughout the specification, it will be understood that when an element is referred to as being “connected (accessed, contacted, coupled) to” another element, it includes “direct connection” as well as “indirect connection” in which the other member is positioned between the parts. Also, it will also be understood that when a component “includes” an element, unless stated otherwise, it should be understood that the component does not exclude other elements, but can further include the other elements.

The terms used in the specification are only examples for describing a specific embodiment but do not limit such embodiments. Singular forms are intended to include plural forms unless the context clearly indicates otherwise. In the specification, it will be further understood that the terms “comprise” and “include” specify the presence of stated features, integers, steps, operations, elements, components, and/or combinations thereof, but do not preclude in advance the possibility of the presence or addition of one or more other features, integers, steps, operations, elements, components, and/or combinations.

Hereinafter, embodiments of the present disclosure will be described in detail with reference to the accompanying drawings.

A method for manufacturing a cation exchange membrane for a fuel cell according to an embodiment of the present disclosure will be described.

Polymer electrolyte membrane fuel cells (PEMFC) have been studied extensively due to their advantages of high current density and environmental friendliness. Among the components of a fuel cell, a cation exchange membrane is a polymer electrolyte membrane responsible for proton transfer, and is a key component that determines the performance of the fuel cell. Perfluorocarbon-based ion exchange membranes, represented by Nafion, have been mainly used in these components, but in terms of full commercialization, they have limitations such as high price due to a complex synthesis process and high fuel permeability.

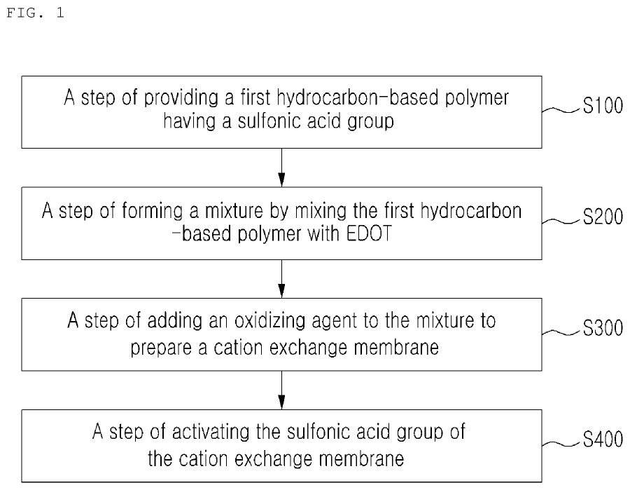

FIG. 1 schematically illustrates a manufacturing process of a cation exchange membrane for a fuel cell.

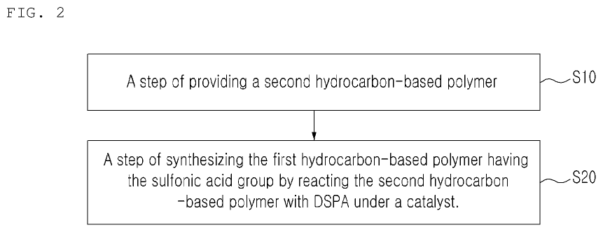

FIG. 2 schematically illustrates a process of synthesizing a first hydrocarbon-based polymer.

A method for manufacturing a cation exchange membrane for a fuel cell according to one example of the above embodiments may include the following steps. The following steps will be described with reference to FIG. 1:

A step of providing a first hydrocarbon-based polymer having a sulfonic acid group (S100), a step of forming a mixture (S200) by mixing the first hydrocarbon-based polymer with 3,4-ethylenedioxythiophene (EDOT), a step of adding an oxidizing agent to the mixture to prepare a cation exchange membrane (S300), and a step of activating the sulfonic acid group of the cation exchange membrane (S400).

A sulfonic acid group is an atomic group with a structure in which a hydroxyl group has been removed from a sulfuric acid molecule, and is a monovalent atomic group consisting of one hydrogen atom, one sulfur atom, and three oxygen atoms. Its chemical formula is SO₃H. In addition, the sulfonation reaction refers to a reaction that generates a RSO₃H type compound by introducing the sulfonic acid group (SO₃H) into an organic compound molecule. The R may be alkyl or aryl, and this sulfonation reaction is an important reaction in the production of dyes or surfactants. For example, there is a reaction in which benzene and fuming sulfuric acid produce benzenesulfonic acid.

3,4-ethylenedioxythiophene (EDOT) is an organosulfur compound with the chemical formula C₂H₄O₂C₄H₂S. The EDOT molecule is composed of thiophene substituted with ethylene glycol units at positions 3 and 4, and is characterized by being colorless and viscous. EDOT to is also a precursor poly (3,4-ethylenedioxythiophene) (PEDOT), a polymer used in electrochromic displays, photovoltaic cells, electroluminescent displays, printed wiring, and sensors.

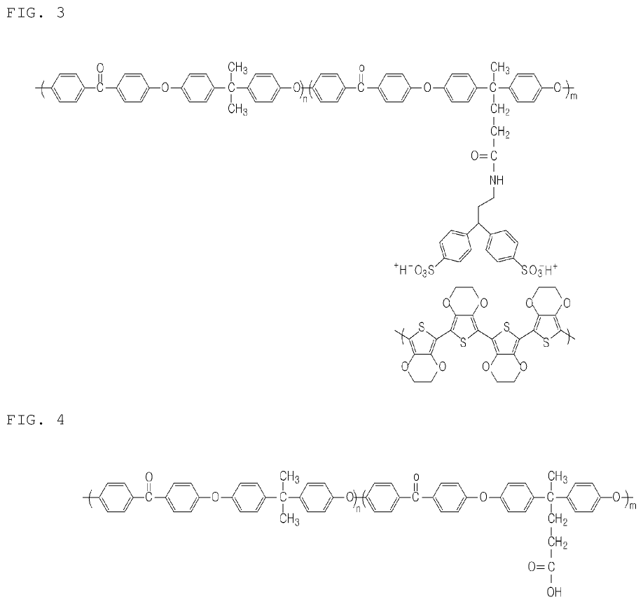

FIG. 3 illustrates a chemical structure of DSPAKE:PEDOT in which hydrophobic PEDOT is blended to improve the proton conductivity, water uptake, and swelling ratio of a proton exchange membrane.

A mixture having the chemical structure shown in FIG. 3 may be formed through the step of forming a mixture by mixing the first hydrocarbon-based polymer with 3,4-ethylenedioxythiophene (EDOT) (S200).

In the method of manufacturing a cation exchange membrane for a fuel cell according to an example of the above embodiment, the step of providing the first hydrocarbon-based polymer having the sulfonic acid group will be described.

The following steps will be described with reference to FIG. 2.

In the method for manufacturing a cation exchange membrane for a fuel cell, the step of providing the first hydrocarbon-based polymer having the sulfonic acid group may include the steps of providing a second hydrocarbon-based polymer (S10), and synthesizing the first hydrocarbon-based polymer having the sulfonic acid group by reacting the second hydrocarbon-based polymer with dual sulfonated poly (arylene ether ketone) (DSPAEK) under a catalyst (S20).

In the method of manufacturing a cation exchange membrane for a fuel cell according to one example of the above embodiments, the second hydrocarbon-based polymer may be polymerized using any one or a mixture of monomers selected from the group consisting of 4,4-bis (4-hydroxyphenyl) valeric acid (BPVA), 4,4-diflourobenzophenol (DFBP), and bisphenol A.

The bisphenol A is a compound mainly used in the production of various plastics. It is a colorless solid, soluble in most common organic solvents, but insoluble in water. BPA is produced on a large scale through the condensation reaction of phenol and acetone, and the global production scale is expected to reach 10 million tons by 2022.

The single largest application of BPA is as a co-monomer in polycarbonate production, accounting for 65 to 70% of all BPA production. The manufacture of epoxy resins and vinyl ester resins accounts for 25 to 30% of BPA use. The remaining 5% is used as the main ingredient in many high-performance plastics and as an additive in PVC, polyurethane, thermal paper, and many other materials.

In the present disclosure, the BPA, BPVA, and DFBP may be used as a monomer for the synthesis of the hydrocarbon-based polymer such as poly ether ether ketone (PEEK), poly arylene ether sulfone (PAES), polybenzimidazol (PBI), poly fluorine biphenyl indole (PFBI), and poly arylene ether ketone (PAEK).

FIG. 4 illustrates a chemical structure of hydrocarbon-based polymer, PAEK through amidation synthesis.

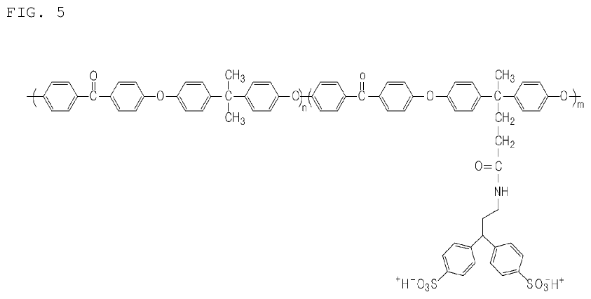

FIG. 5 illustrates a chemical structure of sulfonated DSPAEK for use in a fuel cell and proton exchange membrane.

As an example of the above embodiment, in the method for manufacturing a cation exchange membrane for a fuel cell, the second hydrocarbon-based polymer may be any one selected from the group consisting of poly ether ether ketone (PEEK), poly arylene ether sulfone (PAES), polybenzimidazole (PBI), poly fluorine biphenyl indole (PFBI), and poly arylene ether ketone (PAEK).

Referring to FIG. 4, the structure of the PAEK may be identified.

Referring to FIG. 5, in the step (S20) of synthesizing the first hydrocarbon-based polymer having the sulfonic acid group by reacting the second hydrocarbon-based polymer with dual sulfonated poly (arylene ether ketone) (DSPAEK) under a catalyst, when PAEK is used as the second hydrocarbon-based polymer, the structure of synthesized DSPAEK may be identified.

As an example of the above embodiment, in the method for manufacturing a cation exchange membrane for a fuel cell, the catalyst may include one or more selected from the group consisting of O-(benzotriazole-1-yl)-N,N,N,N-tetramethyluroniumtetrafluoroborate (TBTU) and (N,N-Diisopropylethylamine (DIPEA).

As an example of the above embodiment, in the method for manufacturing a cation exchange membrane for a fuel cell, in the step of synthesizing the first hydrocarbon-based polymer having the sulfonic acid group by reacting the second hydrocarbon-based polymer with dual sulfonated poly (arylene ether ketone) (DSPAEK) under the catalyst, the reaction is an amidation reaction, the first hydrocarbon-based polymer having the sulfonic acid group is a double sulfonated hydrocarbon-based polymer.

The amidation reaction is a reaction to introduce an amide group into an organic compound molecule. The amide is a compound in which the hydrogen atom of ammonia or amine is replaced with an acid group (acyl group) or a metal atom. Those substituted with an acyl group, except for formamide, are mostly colorless crystals and are used as raw materials for organic synthesis, while those substituted with a metal are white solids that decompose to generate ammonia when water is added. The amides may be produced through a condensation reaction between amines and carboxylic acids.

As an example of the above embodiment, there may be a method for manufacturing a cation exchange membrane for a fuel cell, wherein the oxidizing agent is sodium persulfate (SPS).

Sodium persulfate (SPS) is sodium persulfate, an inorganic compound with the chemical formula Na₂S₂O₈, and is the sodium salt of peroxydisulfuric acid (H₂S₂O₈), an oxidizing agent. SPS is a white solid, soluble in water, has little hygroscopicity and has a long lifespan. Sodium persulfate (SPS) is a special oxidizing agent frequently used in the chemical industry, and is classically used in Elbs persulfate oxidation reaction, Boyland-Sims oxidation reaction, radical reaction, and the like.

A cation exchange membrane for a fuel cell according to an embodiment of the present disclosure will be described.

An example of the above embodiment, a cation exchange membrane for a fuel cell may include a first hydrocarbon-based polymer and poly (3,4-ethylenedioxythiophene) (PEDOT), the structure of the first hydrocarbon-based polymer has a main chain in the form of a carbon ring, the functional group of the first hydrocarbon-based polymer includes a sulfonic acid group, the first hydrocarbon-based polymer and the PEDOT are mixed in a structure that exerts steric hindrance and electrostatic interaction with each other.

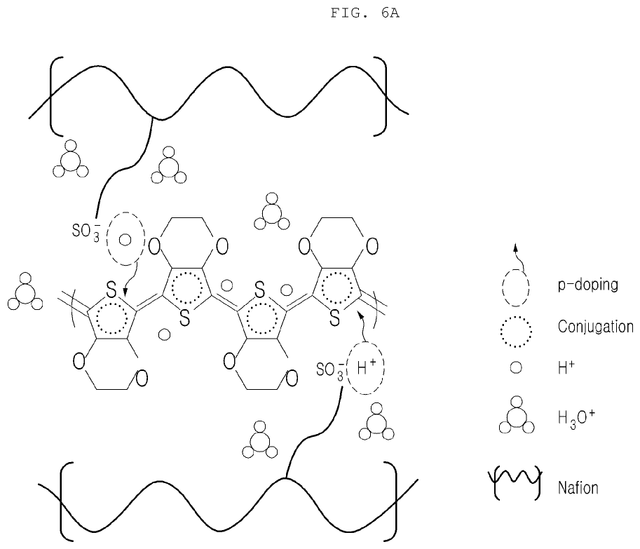

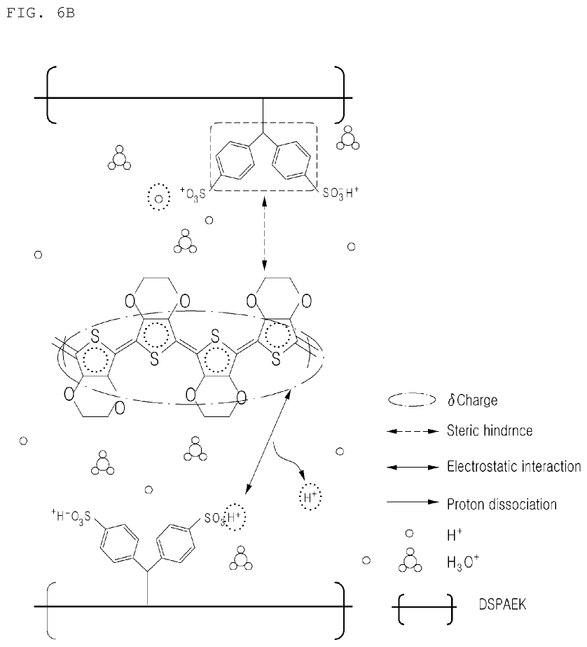

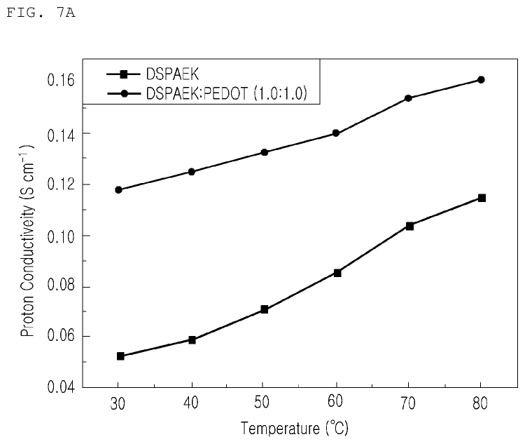

FIG. 6 schematically illustrates a doping process due to an attraction between a flexible structure such as Nafion and PEDOT, and a proton dissociation process without doping due to steric hindrance in the case of hydrocarbon-based polymers, respectively.

The above embodiment and steric effect will be described with reference to FIG. 6.

Steric effect refers to the effect that the size of the substituent shape that exists close to the reaction center has on the reactivity of a substance. It is one of the important substituent effects along with electronic effects such as polarity effect (inductive effect) and resonance effect (mesomeric effect). When this effect acts to impede the progress of a reaction, it is called steric hindrance, and when it acts to promote the progress of a reaction, it is called steric acceleration.

For example, if there are large substituents crowded around the carbon atom attacked by anonoid reagents, they blocks the reagent's access. For this reason, it is difficult for S_{N}2-type reactions in a bimolecular mechanism to occur due to steric hindrance from the substituents. However, in the S_{N}1-type reaction of one-molecule mechanism, a rate-determining step is the process of generating carbonium ions, and the reaction is promoted because a spacing between substituents is widened there and exchange repulsion is relaxed.

In the case of one example of the embodiment, the characteristic corresponding to steric hindrance among the steric effects is used. The hydrocarbon-based polymer has a chemical structure in which the main chain consists of a ring, and protons are not doped due to steric hindrance with PEDOT, and the electrostatic attraction with PEDOT affects proton dissociation, resulting in higher ionic conductivity.

This result is in contrast to the previously used Nafion.

Since Nafion has a flexible main chain chemical structure, a distance between Nafion and PEDOT is relatively close compared to the hydrocarbon-based polymer, so deprotonation occurs and doping occurs. As a result, when PEDOT is introduced into Nafion, ionic conductivity is rather lower than before PEDOT is introduced.

With reference to (a) in FIG. 6, it can be seen that it can maintain a relatively close distance to PEDOT due to flexible main chain structure of Nafion and deprotonation and doping can be visually confirmed.

With reference to (b) in FIG. 6, it can be seen that, unlike the case of Nafion, a relatively long distance can be maintained between DSPAEK and PEADOT due to the effect of steric hindrance. This is because a cyclic hydrocarbon exists between the carbon main chain and the sulfone group.

As an example of the above embodiment, in the cation exchange membrane for a fuel cell, the first hydrocarbon-based polymer is any one selected from the group consisting of sulfonated poly ether ether ketone (SPEEK), surfonated poly arylene ether sulfone (SPAES), surfonated polybenzimidazole (SPBI), sulfonated poly fluorine biphenyl indole (SPFBI), and surfonated poly arylene ether ketone (SPAEK).

As an example of the above embodiment, the cation exchange membrane for a fuel cell may have the structure of the following formula (1).

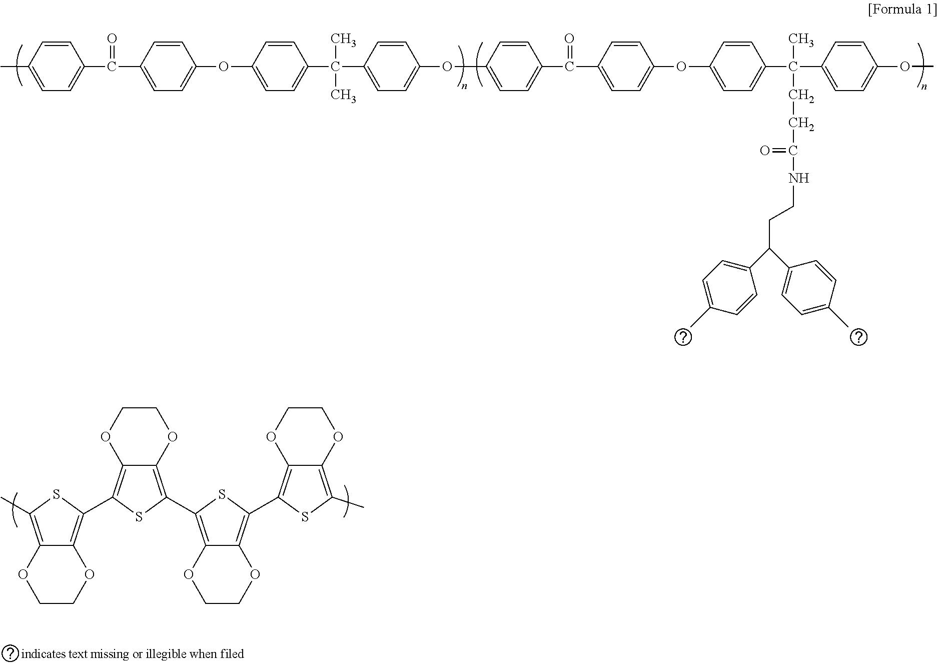

In above Formula 1, n has a value of 0<n<1, and m has a value of 0<m<1, and synthesis is performed as (m+n)=1.

As an example of the above embodiment, in the cation exchange membrane for a fuel cell, the PEDOT is mixed at a molar ratio of 0.4 to 2 with respect to 1 mole of the first hydrocarbon-based polymer.

In this case, as the molar ratio of the first hydrocarbon-based polymer and the PEDOT changes, the properties such as water uptake and swelling ratio of the cation exchange membrane for a fuel cell change. As the ratio of hydrophobic PEDOT increases, both water uptake and swelling ratio tends to decrease. This is because the proportion of hydrophobic PEDOT increases and an interaction between the hydrophilic sulfonic acid group and PEDOT increases.

The water uptake refers to the ratio of water weight to a total weight. In other words, when a sample such as a fiber achieves moisture balance from a low moisture content under standard conditions, the water uptake refers to a value calculated as a percentage by dividing a difference between before and after drying by the weight before drying.

The swelling ratio refers to a degree to which a sample, such as fiber, expands as the water uptake increases, expressed as a percentage of the original size. In other words, the swelling ratio means that the degree to which the sample expands as the proportion of water weight in the total weight increases is quantified.

When the water uptake and swelling ratio of the proton exchange membrane are lowered as in an example of the above embodiments, excellent effects can be obtained in terms of ionic conductivity and mechanical stability.

A fuel cell according to an embodiment of the present disclosure will be described.

As an example of the above embodiment, a fuel cell comprising an anode, a cathode, and a polymer electrolyte membrane positioned between the anode and the cathode, wherein the polymer electrolyte membrane is the cation exchange membrane for a fuel cell described above may be provided.

The description of the cation exchange membrane for a fuel cell is omitted since it has been specifically described above.

Due to the excellent properties of the cation exchange membrane for a fuel cell, a fuel cell including the cation exchange membrane also maintains excellent performance such as improved ionic conductivity and mechanical stability.

### Preparation Example 1. DSPAEK:PEDOT (1.0:0.5)

A cation exchange membrane for a fuel cell was manufactured with a molar ratio of DSPAEK and PEDOT of 1.0:0.5.

The manufacturing process of DSPAEK:PEDOT (1.0:0.5) will be described with reference to FIGS. 1 and 2.

The DSPAEK:PEDOT (1.0:0.5) was manufactured by the steps of providing PAEK (S10); synthesizing the PAEK into DSPAEK through an amidation reaction under DSPA, TBTU, and DIPEA (S20); forming a mixture by mixing the DSPAEK with EDOT such that the molar ratio of DSPAEK and PEDOT is 1.0:0.5 (S200); preparing a cation exchange membrane by adding an oxidizing agent, sodium persulfate, to the mixture (S300); and activating the sulfonic acid group of the cation exchange membrane using 2M HCl (S400).

### Preparation Example 2. DSPAEK:PEDOT(1.0:1.0)

A cation exchange membrane for a fuel cell was manufactured with a molar ratio of DSPAEK and PEDOT of 1.0:1.0.

The manufacturing process of DSPAEK:PEDOT (1.0:1.0) will be described with reference to FIGS. 1 and 2.

The DSPAEK:PEDOT (1.0:1.0) was manufactured by the steps of providing PAEK (S10); synthesizing the PAEK into DSPAEK through an amidation reaction under DSPA, TBTU, and DIPEA (S20); forming a mixture by mixing the DSPAEK with EDOT such that the molar ratio of DSPAEK and PEDOT is 1.0:1.0 (S200); preparing a cation exchange membrane by adding an oxidizing agent, sodium persulfate, to the mixture (S300); and activating the sulfonic acid group of the cation exchange membrane using 2M HCl (S400).

### Preparation Example 3. DSPAEK:PEDOT (1.0:1.5)

A cation exchange membrane for a fuel cell was manufactured with a molar ratio of DSPAEK and PEDOT of 1.0:1.5.

The manufacturing process of DSPAEK:PEDOT (1.0:1. 5) will be described with reference to FIGS. 1 and 2.

The DSPAEK:PEDOT (1.0:1.5) was manufactured by the steps of providing PAEK (S10); synthesizing the PAEK into DSPAEK through an amidation reaction under DSPA, TBTU, and DIPEA (S20); forming a mixture by mixing the DSPAEK with EDOT such that the molar ratio of DSPAEK and PEDOT is 1.0:1.5 (S200); preparing a cation exchange membrane by adding an oxidizing agent, sodium persulfate, to the mixture (S300); and activating the sulfonic acid group of the cation exchange membrane using 2M HCl (S400).

### Comparative Preparation Example 1. SPAES:PEDOT

A cation exchange membrane for a fuel cell was prepared by mixing SPAES and PEDOT.

The manufacturing process of SPAES:PEDOT will be described with reference to FIGS. 1 and 2.

The SPAES:PEDOT was manufactured by the steps of providing PAES (S10); synthesizing the PAES into SPAES through an amidation reaction (S20); forming a mixture by mixing the SPAES with EDOT (S200); preparing a cation exchange membrane by adding an oxidizing agent to the mixture (S300); and activating the sulfonic acid group of the cation exchange membrane using 2M HCl (S400).

### Comparative Preparation Example 2. SPFBI:PEDOT

A cation exchange membrane for a fuel cell was prepared by mixing SPFBI and PEDOT.

The manufacturing process of SPFBI:PEDOT will be described with reference to FIGS. 1 and 2.

The SPFBI:PEDOT was manufactured by the steps of providing PFBI (S10); synthesizing the PFBI into SPFBI through an amidation reaction (S20); forming a mixture by mixing the SPFBI with EDOT (S200); preparing a cation exchange membrane by adding an oxidizing agent to the mixture (S300); and activating the sulfonic acid group of the cation exchange membrane using 2M HCl (S400).

### Comparative Preparation Example 3. SPEEK:PEDOT

A cation exchange membrane for a fuel cell was prepared by mixing SPEEK and PEDOT.

The manufacturing process of SPEEK:PEDOT will be described with reference to FIGS. 1 and 2.

The SPEEK:PEDOT was manufactured by the steps of providing PEEK (S10); synthesizing the PEEK into SPEEK through an amidation reaction (S20); forming a mixture by mixing the SPEEK with EDOT (S200); preparing a cation exchange membrane by adding an oxidizing agent to the mixture (S300); and activating the sulfonic acid group of the cation exchange membrane using 2M HCl (S400).

### Experimental Example 1. Analysis of Ionic Conductivity

The change in ionic conductivity due to the introduction of PEDOT in Preparation Example 1, Comparative Preparation Examples 1 to 3, and commercial Nafion polymer was measured and analyzed.

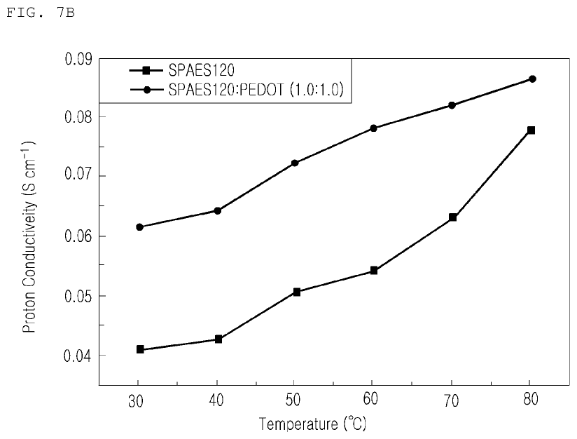

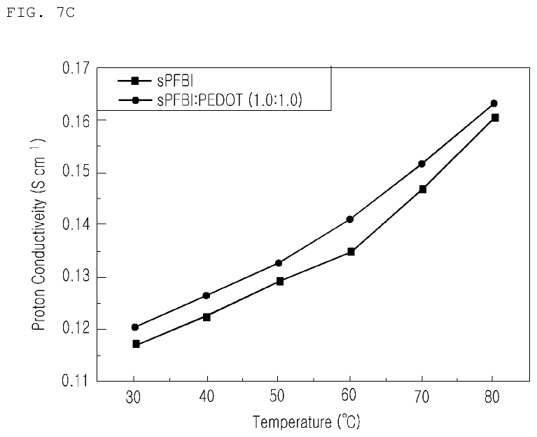

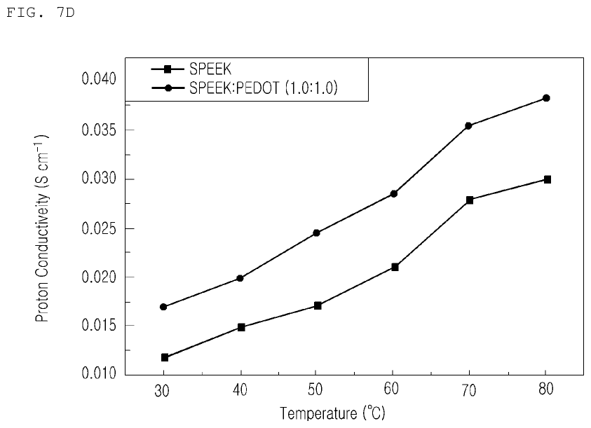

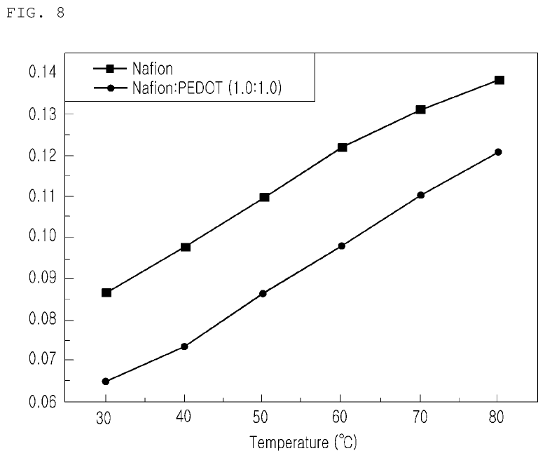

FIG. 7 is a graph showing improved proton conductivity measurements of membranes prepared by blending various hydrocarbon-based polymers with PEDOT.

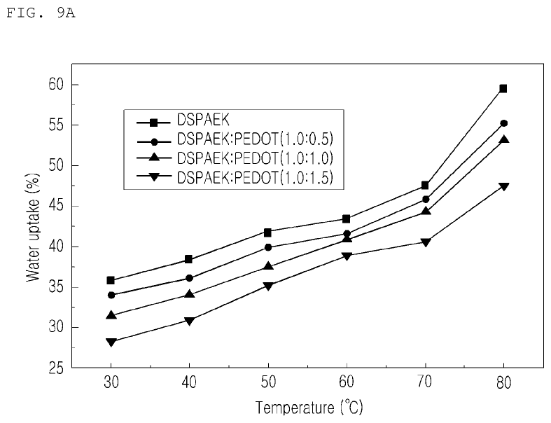

FIG. 8 is a graph showing proton conductivity measurements of an Nafion:PEDOT membrane to confirm a difference when blending PEDOT with a Nafion membrane, which has a flexible main chain, unlike hydrocarbon-based polymers.

Referring to FIGS. 6, 7, and 8, it can be seen that in the case of hydrocarbon-based polymers including DSPAEK, the ionic conductivity increased in all temperature ranges due to the introduction of PEDOT. However, it can be seen that in the case of Nafion, a perfluorinated polymer, the ionic conductivity actually decreased in all temperature ranges due to the introduction of PEDOT.

Referring to (b) in FIG. 6, since the hydrocarbon-based polymer has a chemical structure in which the main chain consists of a ring, protons are not doped due to the influence of PEDOT and steric effect. Additionally, the electrostatic attraction with PEDOT affects the dissociation of protons, resulting in higher ionic conductivity.

Referring to (a) in FIG. 6, it can be seen that, unlike the hydrocarbon-based polymer, the main chain of the commercial Nafion polymer has a flexible chemical structure. Due to the main chain having such a flexible chemical structure, a distance between the commercial Nafion polymer and PEDOT becomes relatively closer compared to hydrocarbon-based polymers, so deprotonation occurs and doping occurs. Due to this difference, unlike hydrocarbon-based polymers, in the case of Nafion, a perfluorinated polymer, the ionic conductivity is lowered in all temperature ranges due to the introduction of PEDOT.

### Experimental Example 2. Analysis of Water Uptake and Swelling Ratio

In order to compare the physical properties of Preparation Examples 1 to 3 and DSPAEK in which no PEDOT is added, the water uptake and swelling ratio of DSPAEK:PEDOT cation exchange membrane prepared by mixing PEDOT with DSPAEK at various ratios were analyzed.

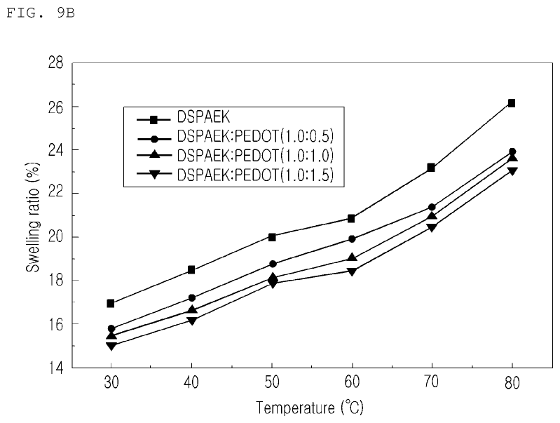

FIG. 9 is a graph showing the water uptake and swelling ratio measurements of a membrane blended with hydrophobic PEDOT and pure membrane, respectively.

Referring to FIG. 9, basically both water uptake and swelling ratio show an increasing trend as the temperature rises. In addition, it can be seen that as the ratio of added PEDOT increases, the water uptake and swelling ratio decrease. This is because the ratio of hydrophobic PEDOT increases and an interaction between the hydrophilic sulfonic acid group and PEDOT increases.

In the above experimental example, the cation exchange membrane with the lowest water uptake and swelling ratio was the DSPAEK:PEDOT (1.0:1.5) proton exchange membrane prepared through the process of Preparation Example 3. In this way, by introducing PEDOT to lower the water uptake and swelling ratio of the proton exchange membrane, excellent effects can be obtained in terms of ionic conductivity and mechanical stability.

The description of the present disclosure is used for illustration and those skilled in the art will understand that the present disclosure can be easily modified to other detailed forms without changing the technical spirit or an essential feature thereof. Therefore, the aforementioned exemplary embodiments are all illustrative in all aspects and are not limited. For example, each component described as a single type may be implemented to be distributed and similarly, components described to be distributed may also be implemented in a combined form.

The scope of the present disclosure is to be defined by the scope of claims provided below, and all variations or modifications that can be derived from the meaning and scope of the claims as well as their equivalents are to be interpreted as being encompassed within the scope of the present disclosure.

What is claimed is:

1. A method for manufacturing a cation exchange membrane for a fuel cell, comprising the steps of:
providing a first hydrocarbon-based polymer having a sulfonic acid group;
forming a mixture by mixing the first hydrocarbon-based polymer with 3,4-ethylenedioxythiophene (EDOT);
adding an oxidizing agent to the mixture to prepare a cation exchange membrane; and
activating the sulfonic acid group of the cation exchange membrane.

2. The method of claim 1, wherein the step of providing the first hydrocarbon-based polymer having the sulfonic acid group includes the steps of:
providing a second hydrocarbon-based polymer; and
synthesizing the first hydrocarbon-based polymer having the sulfonic acid group by reacting the second hydrocarbon-based polymer with DSPA under a catalyst.

3. The method of claim 2, wherein the second hydrocarbon-based polymer is polymerized using any one or a mixture of monomers selected from the group consisting of BPVA, DFBP, and bisphenol A.

4. The method of claim 2, wherein the second hydrocarbon-based polymer is any one selected from the group consisting of poly ether ether ketone (PEEK), poly arylene ether sulfone (PAES), polybenzimidazole (PBI), poly fluorine biphenyl indole (PFBI), and poly arylene ether ketone (PAEK).

5. The method of claim 2, wherein the catalyst includes one or more selected from the group consisting of TBTU and DIPEA.

6. The method of claim 2, wherein the step of synthesize the first hydrocarbon-based polymer having the sulfonic acid group is performed through an amidation reaction, the first hydrocarbon-based polymer having the sulfonic acid group is a double sulfonated hydrocarbon-based polymer.

7. The method of claim 1, wherein the oxidizing agent is sodium persulfate (SPS).

8. A cation exchange membrane for a fuel cell, comprising:
a first hydrocarbon-based polymer and poly (3,4-ethylenedioxythiophene) (PEDOT),
wherein a structure of the first hydrocarbon-based polymer has a main chain in a form of a carbon ring,
a functional group of the first hydrocarbon-based polymer includes a sulfonic acid group,
the first hydrocarbon-based polymer and the PEDOT are mixed in a structure that exerts steric hindrance and electrostatic interaction with each other.

9. The cation exchange membrane for a fuel cell of claim 8, wherein the first hydrocarbon-based polymer is any one selected from the group consisting of SPEEK, SPAES, SPBI, SPFBI, and SPAEK.

10. The cation exchange membrane for a fuel cell of claim 8, wherein the cation exchange membrane for a fuel cell has a structure of Formula 1 below: 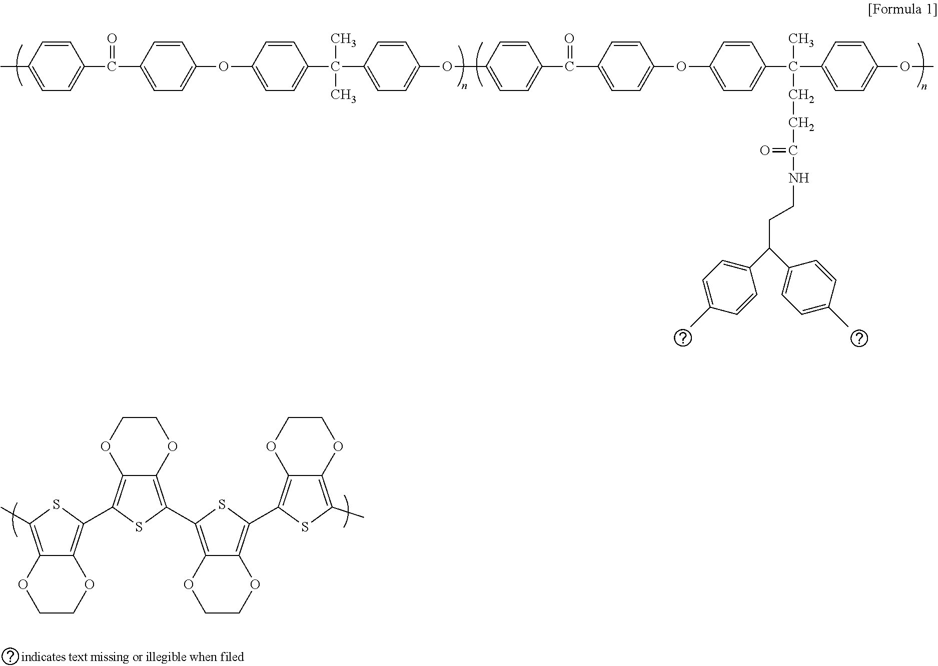
wherein in the Formula 1, n has a value of 0<n<1, and m has a value of 0<m<1, and (m+n)=1.

11. The cation exchange membrane for a fuel cell of claim 8, wherein the PEDOT is mixed at a molar ratio of 0.4 to 2 with respect to 1 mole of the first hydrocarbon-based polymer.

12. a fuel cell comprising an anode, a cathode, and a polymer electrolyte membrane positioned between the anode and the cathode,
wherein the polymer electrolyte membrane is the cation exchange membrane for a fuel cell of claim 1.
